(19) United States
(12) Patent Application Publication
(10) Pub. No.: US 2024/0096522 A1
(43) Pub. Date: Mar. 21, 2024

(54) Method for manufacturing an electrical cable having improved thermal conductivity

(71) Applicant: NEXANS, Courbevoie (FR)

(72) Inventors: Gabriele PEREGO, MILAN (IT); Christelle MAZEL, RUY (FR); Claire GRANGER, VAUX-EN-VELIN (FR)

(21) Appl. No.: 18/267,779

(22) PCT Filed: Dec. 15, 2021
(86) PCT No.: PCT/FR2021/052333

§ 371 Date: Jun. 15, 2023

(30) Foreign Application Priority Data
Dec. 18, 2020 (FR) FR2013644

(51) Int. Cl. H01B 13/14; C08L 23/12; H01B 3/44

(52) U.S. Cl. CPC H01B 13/147; C08L 23/12; H01B 3/441; C08L 2203/202; C08L 2205/02

(57) ABSTRACT

A process is provided for manufacturing a cable having at least one electrically insulating layer obtained from a polymer composition having at least one thermoplastic polymer material based on polypropylene and polyethylene, at least one dielectric liquid, and at least one thermally conductive inorganic filler. The process includes the premixing of the thermally conductive inorganic filler with the polyethylene.

The invention relates to a process for manufacturing a cable comprising at least one electrically insulating layer obtained from a polymer composition comprising at least one thermoplastic polymer material based on polypropylene and polyethylene, at least one dielectric liquid, and at least one thermally conductive inorganic nanofiller, said process involving the premixing of the thermally conductive inorganic nanofiller with the polyethylene.

The invention typically but not exclusively applies to electric cables intended for power transmission, notably to medium-voltage (notably from 6 to 45-60 kV) or high-voltage (notably greater than 60 kV, and which can go up to 400 kV) power cables, whether in direct or alternating current, in the fields of aerial, submarine or terrestrial power transmission.

The invention applies in particular to electric cables with improved thermal conductivity.

A medium-voltage or high-voltage power transmission cable preferably comprises, from the inside to the outside:
an elongated electrically conductive element, notably made of copper or aluminum;
an inner semiconductive layer surrounding said elongated electrically conductive element;
an electrically insulating layer surrounding said inner semiconductive layer;
an outer semiconductive layer surrounding said insulating layer;
optionally an electrical shield surrounding said outer semiconductive layer; and
optionally an electrically insulating protective sheath surrounding said electrical shield.

International patent application WO 2019/072388 A1 discloses a cable comprising an electrically insulating layer obtained from a polymer composition comprising at least one polypropylene-based thermoplastic polymer material and boron nitride having a particle size distribution D50 of not more than 15 pm. More particularly, the electrically insulating layer is made by impregnating the dielectric liquid into the polymer material so as to obtain granules of polymer material impregnated with said dielectric liquid, mixing the granules with a boron nitride powder having a particle size distribution D50 of not more than 15 μm so as to form a polymer composition, and then extruding the polymer composition around the cable core. However, the thermal conductivity properties of the electrically insulating layer thus obtained are not optimized. Moreover, the incorporation of boron nitride or other inorganic fillers into a polymer material is generally difficult to perform due to the presence of agglomerates, which occasionally makes the process long and/or requires special equipment that increases the production cost of the cable.

The aim of the present invention is consequently to overcome the drawbacks of the techniques of the prior art by proposing a process for manufacturing an electric cable, notably a medium-voltage or high-voltage cable, based on propylene polymer(s), said process being easy to perform, inexpensive, not requiring complex equipment, and being able to produce a cable which can operate at temperatures above 70° C., and having improved thermal conductivity properties, while at the same time ensuring good mechanical properties, notably in terms of elongation at break and tensile strength.

The aim is achieved by the invention which will be described hereinbelow.

A first subject of the invention is a process for manufacturing an electric cable comprising at least one elongated electrically conductive element and at least one electrically insulating layer obtained from a polymer composition comprising at least one thermoplastic polymer material based on polypropylene and polyethylene, at least one dielectric liquid, and at least one thermally conductive inorganic nanofiller, said process being characterized in that it comprises at least the following steps:
i) mixing the nanometric thermally conductive inorganic nanofiller with an ethylene polymer to form a nanofilled ethylene polymer,
ii) mixing the nanofilled ethylene polymer with at least one propylene polymer, to form a nanofilled thermoplastic polymer material,
iii) mixing the nanofilled thermoplastic polymer material with the dielectric liquid to form a polymer composition, and
iv) extruding the polymer composition around the elongated electrically conductive element.

The process of the invention is simple to perform, inexpensive, and does not require any complex equipment. Moreover, it produces a cable that can operate at temperatures above 70° C., and which has improved thermal conductivity properties, while at the same time ensuring good mechanical properties.

Dispersing the inorganic nanofiller in the ethylene polymer in step i) before placing it in contact with the propylene polymer in step ii) promotes the dispersion of the inorganic nanofiller in the thermoplastic polymer material, promotes the creation of several percolation levels, and improves the thermal conductivity of the layer thus obtained.

Step i)

Step i) involves mixing the inorganic nanofiller with the ethylene polymer. This step i) may be performed at a temperature ranging from about 140° C. to about 240° C., and preferably from about 160° C. to about 220° C.

Step i) is advantageously performed with a mixer suitable for mixing several solids, for instance a single-screw extruder, a twin-screw extruder, in particular a co-rotating or counter-rotating extruder, a Buss co-kneader, or a closed mixing device.

This step i) may last from about 1 min to about 1 hour, and preferably from about 5 minutes to about 30 minutes.

The duration of step i) depends on the type of mixing device used. In the case of an extrusion device, the duration of this step is referred to as the residence time, rather than the actual duration.

The Thermally Conductive Inorganic Nanofiller

On conclusion of step i), the thermally conductive inorganic nanofiller preferably represents from about 20% to about 80% by weight, and particularly preferably from about 40% to about 75% by weight relative to the total weight of the nanofilled ethylene polymer (i.e. the ethylene polymer and the thermally conductive inorganic nanofiller).

The thermally conductive inorganic nanofiller may have a thermal conductivity of at least about 1 W/m·k at 20° C., and preferably of at least about 5 W/m·k at 20° C.

In the present invention, the thermal conductivity is preferably measured according to the well-known Transient Plane Source or TPS method. Advantageously, the thermal conductivity is measured using a device sold under the reference Hot Disk TPS 2500S by the company Thermoconcept.

The thermally conductive inorganic nanofiller may be chosen from silicates, boron nitride, carbonates, metal oxides, and a mixture thereof, and preferably from silicates, carbonates, metal oxides, and a mixture thereof.

A mixture of the thermally conductive inorganic nanofillers is preferably a mixture of two or three of said thermally conductive inorganic nanofillers.

Among the silicates, mention may be made of aluminum, calcium, or magnesium silicates.

Aluminum silicates are preferred.

The aluminum silicates may be chosen from kaolins and any other mineral or clay predominantly comprising kaolinite.

In the present invention, the term “any other mineral or clay predominantly comprising kaolinite” means any other mineral or clay comprising at least about 50% by weight, preferably at least about 60% by weight, and more preferably at least about 70% by weight, of kaolinite, relative to the total weight of the mineral or clay.

Kaolins, in particular calcined kaolin, are preferred.

Among the carbonates, mention may be made of chalk, calcium carbonate (e.g. aragonite, vaterite, calcite, or a mixture of at least two of the abovementioned compounds), magnesium carbonate, limestone, or any other mineral predominantly comprising calcium carbonate or magnesium carbonate.

In the present invention, the term “any other mineral predominantly comprising calcium carbonate or magnesium carbonate” means any other mineral comprising at least about 50% by weight, preferably at least about 60% by weight, and more preferably at least about 70% by weight, of calcium carbonate or magnesium carbonate, relative to the total weight of the mineral.

Chalk and calcium carbonate are preferred.

Among the metal oxides, mention may be made of aluminum oxide, a hydrated aluminum oxide, magnesium oxide, silicon dioxide, or zinc oxide.

In the present invention, aluminum oxide, also well known as alumina, is a chemical compound having the formula Al₂O₃.

The hydrated aluminum oxide or hydrated alumina may be an aluminum oxide monohydrate or polyhydrate, and preferably monohydrate or trihydrate.

As examples of aluminum oxide monohydrates, mention may be made of boehmite, which is the gamma polymorph of AlO(OH) or Al₂O₃·H₂O; or diaspore, which is the alpha polymorph of AlO(OH) or Al₂O₃·H₂O.

As examples of aluminum oxide polyhydrates, and preferably trihydrates, mention may be made of gibbsite or hydrargillite, which is the gamma polymorph of Al(OH)₃; bayerite, which is the alpha polymorph of Al(OH)₃; or nordstrandite, which is the beta polymorph of Al(OH)₃.

Hydrated aluminum oxide is also well known as “aluminum oxide hydroxide” or “alumina hydroxide”.

Aluminum oxide, magnesium oxide, and silicon dioxide are preferred.

The aluminum oxide (or, respectively, magnesium oxide) is preferably a calcined aluminum oxide (or, respectively, a calcined magnesium oxide).

The silicon dioxide is preferably fumed silica.

According to a particularly preferred embodiment of the invention, the thermally conductive inorganic nanofiller is chosen from kaolins, chalk, a calcined magnesium oxide, fumed silica, and a calcined aluminum oxide.

The thermally conductive inorganic nanofiller of the invention is a nano-sized filler.

The thermally conductive inorganic nanofiller(s) of the invention typically have at least one of their dimensions of nanometric size (10⁻⁹ meter).

More particularly, the nanofiller(s) of the invention (i.e. one or more elementary particles) may have at least one of their dimensions of not more than about 1000 nm (nanometers), preferably not more than about 900 nm, preferably not more than about 800 nm, preferably not more than about 600 nm, and more preferentially not more than about 400 nm.

In addition, the nanofiller(s) of the invention may have at least one of their dimensions of at least about 1 nm, and preferably of at least about 5 nm.

Preferably, the nanofiller(s) of the invention may have at least one of their dimensions ranging from about 1 to 800 nm, and particularly preferably from about 5 to 600 nm.

The use of nanometric thermally conductive inorganic filler nanoparticles improves the thermal conductivity of the polymer composition.

Considering several thermally conductive inorganic filler nanoparticles according to the invention, the term “size” represents the size distribution D50, this distribution being conventionally determined by methods that are well known to those skilled in the art.

The size of the thermally conductive nanofiller(s) according to the invention may be determined, for example, by microscopy, notably by scanning electron microscopy (SEM), by transmission electron microscopy (TEM), or by laser diffraction.

The size distribution D50 is preferably measured by laser diffraction, for example using a laser beam diffraction granulometer. The size distribution D50 indicates that 50% by volume of the particle population has an equivalent sphere diameter less than the given value.

The thermally conductive inorganic nanofiller may be “treated” or “untreated”, and preferably “treated”.

The term “treated thermally conductive inorganic nanofiller” means a thermally conductive inorganic nanofiller that has undergone surface treatment, or in other words, a surface-treated thermally conductive inorganic nanofiller. Said surface treatment notably modifies the surface properties of the thermally conductive inorganic nanofiller, for example to improve the compatibility of the thermally conductive inorganic nanofiller with the thermoplastic polymer material, and notably with the ethylene polymer.

In a preferred embodiment, the thermally conductive inorganic nanofiller of the invention is silanized, or in other words is treated to obtain a silanized thermally conductive inorganic nanofiller.

The surface treatment used to obtain the silanized thermally conductive inorganic nanofiller is notably a surface treatment using at least one silane compound (with or without a coupling agent), this type of surface treatment being well known to those skilled in the art.

Thus, the silanized thermally conductive inorganic nanofiller of the invention may comprise siloxane and/or silane groups on its surface. Said groups may be of the vinylsilane, alkylsilane, epoxysilane, methacryloxysilane, acryloxysilane, am inosilane or mercaptosilane type.

The silane compound used for obtaining the silanized thermally conductive inorganic nanofiller may be chosen from:
alkyltrimethoxysilane or alkyltriethoxysilane, for instance octadecyltrimethoxysilane (OdTMS-C18), octyl(triethoxy)silane (OTES-C8), methyltrimethoxysilane, hexadecyltrimethoxysilane,
vinyltrimethoxysilane or vinyltriethoxysilane,
methacryloxylsilane or acryloxysilane, for instance 3-methacryloxypropylmethyldimethoxysilane, 3-methacryloxypropyltrimethoxysilane, 3-methacryloxypropyltrimethoxysilane, 3-acryloxypropyltrimethoxysilane, and
a mixture thereof.

The thermally conductive inorganic nanofiller may have a specific surface area according to the BET method ranging from about 1 to about 1000 m²/g, preferably from about 50 to about 750 m²/g, and particularly preferably from about 100 to about 500 m²/g.

In the present invention, the specific surface area of the thermally conductive inorganic nanofiller may be readily determined according to the standard DIN 9277 (2010).

The Ethylene Polymer

The ethylene polymer may be an ethylene homopolymer or copolymer.

When the ethylene polymer is an ethylene copolymer, it may be a copolymer of ethylene and an olefin chosen from the following olefins: propylene, 1-butene, isobutylene, 1-pentene, 4-methyl-1-pentene, 1-hexene, 1-octene, 1-decene, 1-dodecene, and a mixture thereof. The olefin is preferably from the following olefins: propylene, 1-hexene and 1-octene.

The ethylene polymer preferably comprises at least about 80 mol % of ethylene, particularly preferably at least about 90 mol % of ethylene, and more particularly preferably at least about 95 mol % of ethylene, relative to the total number of moles of the ethylene polymer.

According to a preferred embodiment of the invention, the ethylene polymer is a low-density polyethylene, a linear low-density polyethylene, a medium-density polyethylene, or a high-density polyethylene, and preferably a linear low-density polyethylene; notably according to the standard ISO 1183A (at a temperature of 23° C.). This is because such a linear low-density polyethylene facilitates step i), i.e. the dispersion of the nanofiller in the ethylene polymer.

The ethylene polymer preferably has an elastic modulus of at least 200 MPa, and particularly preferably of at least 250 MPa.

In the present invention, the elastic modulus or Young's modulus of a polymer (known as the Tensile Modulus) is well known to those skilled in the art, and may be readily determined according to the standard ISO 527-1, -2 (2012). The standard ISO 527 has a first part, noted “ISO 527-1”, and a second part, noted “ISO 527-2” specifying the test conditions relating to the general principles of the first part of the standard ISO 527.

In the present invention, the term “low density” means having a density ranging from about 0.91 to about 0.925 g/cm³, said density being measured according to the standard ISO 1183A (at a temperature of 23° C.).

In the present invention, the term “medium density” means having a density ranging from about 0.926 to about 0.940 g/cm³, said density being measured according to the standard ISO 1183A (at a temperature of 23° C.).

In the present invention, the term “high density” means having a density ranging from 0.941 to 0.965 g/cm³, said density being measured according to the standard ISO 1183A (at a temperature of 23° C.).

The ethylene polymer preferably represents from about 20% to about 80% by weight, and particularly preferably from about 25% to about 60% by weight, relative to the total weight of the nanofilled ethylene polymer (i.e. the ethylene polymer and the thermally conductive inorganic nanofiller).

Step ii)

Step ii) involves mixing the nanofilled ethylene polymer obtained in step i) with at least one propylene polymer, to form a nanofilled thermoplastic polymer material.

This step ii) makes it possible to form a thermoplastic polymer material with several percolation levels.

This step ii) may be performed at a temperature ranging from about 180° C. to about 240° C., and preferably from about 200° C. to about 220° C.

Step ii) is advantageously performed with a mixer suitable for mixing several solids, for instance a single-screw extruder, a twin-screw extruder, in particular a co-rotating or counter-rotating extruder, a Buss co-kneader, or a closed mixing device.

This step ii) may have a residence time ranging from about 1 min to about 1 hour, and preferably from about 5 minutes to about 30 minutes.

The combination of ethylene polymer and propylene polymer makes it possible to obtain a thermoplastic polymer material with good mechanical properties, notably in terms of elastic modulus, and good electrical properties.

The Propylene Polymer

During step ii), the propylene polymer (or propylene polymers when there are several) are used in an amount such that they preferably represent at least about 50% by weight, particularly preferably from about 55% to 90% by weight, and more particularly preferably from about 60% to 85% by weight, relative to the total weight of the thermoplastic polymer material based on polypropylene and polyethylene.

The propylene polymer may be a propylene homopolymer or copolymer P₁, and preferably a propylene copolymer P₁.

The propylene homopolymer P₁ preferably has an elastic modulus ranging from about 1250 to 1600 MPa.

In the present invention, the elastic modulus or Young's modulus of a polymer (known as the Tensile Modulus) is well known to those skilled in the art, and may be readily determined according to the standard ISO 527-1, -2 (2012). The standard ISO 527 has a first part, noted “ISO 527-1”, and a second part, noted “ISO 527-2” specifying the test conditions relating to the general principles of the first part of the standard ISO 527.

The propylene homopolymer P₁ may represent at least 10% by weight, and preferably from 15% to 30% by weight, relative to the total weight of the thermoplastic polymer material based on polypropylene and polyethylene.

As examples of propylene copolymers P₁, mention may be made of copolymers of propylene and olefin, the olefin being notably chosen from ethylene and an olefin al other than propylene.

The ethylene or the olefin al other than propylene of the propylene-olefin copolymer preferably represents not more than about 45 mol %, particularly preferably not more than about 40 mol %, and more particularly preferably not more than about 35 mol %, relative to the total number of moles of propylene-olefin copolymer.

The molar percentage of ethylene or olefin al in the propylene copolymer P₁ may be determined by nuclear magnetic resonance (NMR), for example according to the method described in Masson et al., Int. J. Polymer Analysis & Characterization, 1996, volume 2, 379-393.

The olefin α₁ other than propylene may have the formula CH₂═CH—R¹, in which R¹ is a linear or branched alkyl group containing from 2 to 12 carbon atoms, notably chosen from the following olefins: 1-butene, 1-pentene, 4-methyl-1-pentene, 1-hexene, 1-octene, 1-decene, 1-dodecene, and a mixture thereof.

Propylene-ethylene copolymers are preferred as the propylene copolymer P₁.

The propylene copolymer P₁ may be a homophasic propylene copolymer or a heterophasic propylene copolymer, and preferably a homophasic propylene copolymer.

In the invention, the homophasic propylene copolymer P₁ preferably has an elastic modulus ranging from about 600 to 1200 MPa, and particularly preferably ranging from about 800 to 1100 MPa.

Advantageously, the homophasic propylene copolymer P₁ is a statistical propylene copolymer P₁.

The ethylene or olefin al other than propylene of the homophasic propylene copolymer P₁ preferably represents not more than about 20 mol %, particularly preferably not more than about 15 mol %, and more particularly preferably not more than about 10 mol %, relative to the total number of moles of the homophasic propylene copolymer P₁.

The ethylene or olefin al other than propylene of the homophasic propylene copolymer P₁ may represent at least about 1 mol %, relative to the total number of moles of homophasic propylene copolymer P₁.

An example of a statistical propylene copolymer P₁ that may be mentioned is the product sold by the company Borealis under the reference Bormed® RB 845 MO or the product sold by the company Total Petrochemicals under the reference PPR3221.

The heterophasic (or heterophase) propylene copolymer P₁ may comprise a thermoplastic propylene phase and a thermoplastic elastomer phase of copolymer of ethylene and an olefin α₂.

The olefin α₂ of the thermoplastic elastomer phase of the heterophasic propylene copolymer P₁ may be propylene.

The thermoplastic elastomer phase of the heterophasic propylene copolymer P₁ may represent at least about 20% by weight, and preferably at least about 45% by weight, relative to the total weight of the heterophasic propylene copolymer P₁.

The heterophasic propylene copolymer P₁ preferably has an elastic modulus ranging from about 50 to about 1200 MPa, and particularly preferably: either an elastic modulus ranging from about 50 to about 550 MPa, and more particularly preferably ranging from about 50 to about 300 MPa; or an elastic modulus ranging from about 600 to about 1200 MPa, and more particularly preferably ranging from about 800 to about 1200 MPa.

As an example of a heterophasic propylene copolymer, mention may be made of the heterophasic propylene copolymer sold by the company LyondellBasell under the reference Adflex® Q 200 F, or the heterophasic copolymer sold by the company LyondellBasell under the reference EP® 2967.

The propylene homopolymer or copolymer P₁ may have a melting point of greater than about 110° C., preferably greater than about 130° C., particularly preferably greater than about 135° C., and more particularly preferably ranging from about 140 to about 170° C.

The propylene homopolymer or copolymer P₁ may have an enthalpy of fusion ranging from about 20 to 100 J/g.

Preferably, the propylene homopolymer P₁ has an enthalpy of fusion ranging from about 80 to 90 J/g.

The homophasic propylene copolymer P₁ preferably has an enthalpy of fusion ranging from about 40 to 90 J/g, and particularly preferably ranging from 50 to 85 J/g.

The heterophasic propylene copolymer P₁ preferably has an enthalpy of fusion ranging from about 20 to 50 J/g.

The propylene homopolymer or copolymer P₁ may have a melt flow index ranging from 0.5 to 3 g/10 min; notably determined at about 230° C. with a load of about 2.16 kg according to the standard ASTM D1238-00, or the standard ISO 1133.

The homophasic propylene copolymer P₁ preferably has a melt flow index ranging from 1.0 to 2.75 g/10 min, and more preferably ranging from 1.2 to 2.5 g/10 min; notably determined at about 230° C. with a load of about 2.16 kg according to the standard ASTM D1238-00, or the standard ISO 1133.

The heterophasic propylene copolymer P₁ may have a melt flow index ranging from about 0.5 to 1.3 g/10 min, and preferably ranging from about 0.6 to 1.2 g/10 min; notably determined at about 230° C. with a load of about 2.16 kg according to the standard ASTM D1238-00, or the standard ISO 1133.

The propylene homopolymer or copolymer P₁ may have a density ranging from about 0.81 to about 0.92 g/cm³; notably determined according to the standard ISO 1183A (at a temperature of 23° C.).

The propylene copolymer P₁ preferably has a density ranging from 0.85 to 0.91 g/cm³ and particularly preferably ranging from 0.87 to 0.91 g/cm³; notably determined according to the standard ISO 1183A (at a temperature of 23° C.).

Step ii) may involve several propylene polymers.

In this embodiment, step ii) involves mixing the nanofilled ethylene polymer obtained in step i) with several propylene polymers, to form a nanofilled thermoplastic polymer material.

The propylene polymers may be several different propylene copolymers P₁, notably two different propylene copolymers P₁, said propylene copolymers P₁ being as defined above.

In particular, step ii) may use a homophasic propylene copolymer (as first propylene copolymer P₁) and a heterophasic propylene copolymer (as a second propylene copolymer P₁), or two different heterophasic propylene copolymers.

When a homophasic propylene copolymer and a heterophasic propylene copolymer are used, said heterophasic propylene copolymer preferably has an elastic modulus ranging from about 50 to 300 MPa.

According to one embodiment of the invention, the two heterophasic propylene copolymers have a different elastic modulus. Preferably, a first heterophasic propylene copolymer has an elastic modulus ranging from about 50 to about 550 MPa, and particularly preferably ranging from about 50 to about 300 MPa; and a second heterophasic propylene copolymer has an elastic modulus ranging from about 600 to about 1200 MPa, and more particularly preferably ranging from about 800 to about 1200 MPa.

Advantageously, the first and second heterophasic propylene copolymers have a melt flow index as defined in the invention.

These combinations of propylene copolymers P₁ may advantageously allow the mechanical properties of the electrically insulating layer to be improved. In particular, the combination affords optimized mechanical properties for the electrically insulating layer, notably in terms of elongation at break, and flexibility; and/or allows a more homogeneous electrically insulating layer to be formed, and notably favors the dispersion of the dielectric liquid in the thermoplastic polymer material based on polypropylene and polyethylene of said electrically insulating layer.

Moreover, this combination of propylene copolymers P₁ with an ethylene polymer allows further improvement of the mechanical properties of the electrically insulating layer, while at the same time ensuring good thermal conductivity.

According to a preferred embodiment of the invention, the propylene copolymer P₁ or the propylene copolymers P₁ when there are several, represent at least about 50% by weight, preferably from about 55% to 90% by weight, and particularly preferably from about 60% to 90% by weight, relative to the total weight of the thermoplastic polymer material based on polypropylene and polyethylene.

The homophasic propylene copolymer P₁ may represent at least 30% by weight, and preferably from 40% to 80% by weight, relative to the total weight of the thermoplastic polymer material based on polypropylene and polyethylene.

The heterophasic propylene copolymer P₁, or the heterophasic propylene copolymers P₁ when there are several, may represent from about 1% to 50% by weight, preferably from about 5% to 45% by weight, and particularly preferably from about 10% to 50% by weight, relative to the total weight of the thermoplastic polymer material based on polypropylene and polyethylene.

The ethylene polymer preferably represents from about 5% to about 50% by weight, and particularly preferably from about 10% to about 40% by weight, relative to the total weight of the thermoplastic polymer material based on polypropylene and polyethylene.

Step iii)

Step iii) involves mixing the nanofilled thermoplastic polymer material obtained in step ii) with the dielectric liquid to form a polymer composition.

This step iii) makes it possible to place the dielectric liquid, optionally comprising one or more additives, in contact with the nanofilled thermoplastic polymer material.

Step iii) is preferably performed at a temperature ranging from about 170° C. to about 240° C., and particularly preferably from about 180° C. to about 220° C.

Step iii) is preferably performed using an extruder.

The extruder preferably comprises a screw.

According to one embodiment of the invention, the extruder used in step iii) of the process of the invention is a single-screw extruder. It thus comprises a single screw.

The extruder may be equipped with at least one feed hopper connected to the extruder and configured to introduce or inject constituents into the extruder.

According to a particularly preferred embodiment of the invention, step iii) is performed according to the following substeps:
iii-1) introducing the dielectric liquid into an extruder by means of a feed hopper,
iii-2) introducing the nanofilled thermoplastic polymer material [obtained from step ii)], notably in the form of granules, into the extruder by means of the feed hopper,
iii-3) mixing the dielectric liquid and the nanofilled thermoplastic polymer material in the extruder so as to form the polymer composition, and
iii-4) melting the thermoplastic polymer material.

In step iii), the dielectric liquid and the nanofilled thermoplastic polymer material are preferably fed into a first zone of the screw, referred to as the feed zone (substeps iii-1 and iii-2)).

The feed zone or first screw zone is notably located at the inlet of the extruder.

The resulting mixture may then be fed from the feed zone to one or more intermediate zones of the screw allowing the polymer composition to be transported to the extruder head located at the extruder outlet, and the thermoplastic polymer material to be gradually melted (substeps iii-3) and iii-4)).

Substep iii-1) (or substep iii-2, respectively) may be performed at a pressure of not more than 5 bar, preferably not more than 3 bar, and preferably not more than 1.5 bar. In a particularly preferred embodiment, substep iii-1) (or substep iii-2, respectively) is performed at atmospheric pressure, namely at a pressure of about 1 bar.

Before substep iii-2) of introducing the nanofilled thermoplastic polymer material into the extruder, said nanofilled thermoplastic polymer material may be preheated to a temperature ranging from 40° C. to 100° C.

According to a preferred embodiment, substeps iii-1) and iii-2) are concomitant. In other words, the dielectric liquid is fed simultaneously with the nanofilled thermoplastic polymer material in solid form into the feed zone through the hopper of the extruder.

In substeps iii-3) and iii-4), the polymer composition is fed (continuously) from the feed zone to one or more intermediate zones of the screw allowing transport of the composition to the extruder head located at the extruder exit, and gradual melting of the polymer.

The intermediate zones are located between the feed zone and the extruder head.

The intermediate zones may comprise one or more heating zones, allowing the temperature in the extruder to be controlled.

The molten state (melt) is reached when the thermoplastic polymer material is heated to a temperature greater than or equal to its melting point.

According to a particularly preferred embodiment of the invention, substeps iii-3) and iii-4) are concomitant.

Substep iii-4) [or substep iii-3), respectively] may be performed at a temperature ranging from about 170° C. to about 240° C., and particularly preferably from about 180° C. to about 220° C.

Substep iii-4) [or substep iii-3), respectively] may be performed at a pressure ranging from 1 to 300 bar.

The dielectric liquid and the nanofilled thermoplastic polymer material may be placed in contact in the feed hopper or in the extruder, notably in the feed zone; and preferably in the feed hopper.

The placing of the filler-charged dielectric liquid in contact with the thermoplastic polymer material may be performed at a temperature ranging from about 15° C. to about 80° C., and preferably at ambient temperature.

In the present invention, the term “ambient temperature” means a temperature ranging from about 15 to about 35° C., and preferably ranging from about 20 to about 25° C.

The placing in contact is preferably performed at a pressure of not more than 5 bar, preferably not more than 3 bar, and preferably not more than 1.5 bar. In a particularly preferred embodiment, the placing in contact is performed at atmospheric pressure, namely at a pressure equal to about 1 bar.

Substep iii-3) or the placing in contact of the dielectric liquid and the nanofilled thermoplastic polymer material preferably does not include a step of impregnating the nanofilled thermoplastic polymer material with the dielectric liquid. In other words, the dielectric liquid is not completely absorbed by the nanofilled thermoplastic polymer material, notably before the nanofilled thermoplastic polymer material is melted according to substep iii-4). The reason for this is that a conventional impregnation step is time-consuming and requires a minimum amount of dielectric liquid (about 10-15% relative to the total mass of the polymer composition).

According to a particularly preferred embodiment of the invention, the extruder comprises a barrier screw and/or a grooved barrel. The use of a specific barrel (i.e. grooved barrel) and/or a specific screw (i.e. barrier screw) makes it possible to obtain a homogeneous composition that is easy to extrude, while at the same time avoiding or limiting the formation of structural defects in the resulting thermoplastic electrically insulating layer.

On conclusion of step iii), the dielectric liquid forms an intimate mixture with the nanofilled thermoplastic polymer material.

The Dielectric Liquid

The dielectric liquid may comprise at least one liquid chosen from a mineral oil (e.g. naphthenic oil, paraffinic oil or aromatic oil), a plant oil (e.g. soybean oil, linseed oil, rapeseed oil, corn oil or castor oil), a synthetic oil such as an aromatic hydrocarbon (alkylbenzene, alkylnaphthalene, alkylbiphenyl, alkyldiarylethylene, etc.), a silicone oil, an ether oxide, an organic ester, and an aliphatic hydrocarbon, and preferably from a mineral oil (e.g. naphthenic oil, paraffinic oil or aromatic oil), a plant oil (e.g. soybean oil, linseed oil, rapeseed oil, corn oil or castor oil), a synthetic oil such as an aromatic hydrocarbon (alkylbenzene, alkylnaphthalene, alkylbiphenyl, alkyldiarylethylene, etc.), a silicone oil, and an aliphatic hydrocarbon.

The liquid component of the dielectric liquid is generally liquid at about 20-25° C.

The dielectric liquid may comprise at least about 70% by weight of the liquid component of the dielectric liquid, and preferably at least about 80% by weight of the liquid component of the dielectric liquid, relative to the total weight of the dielectric liquid.

Mineral oil is preferred as a liquid component of the dielectric liquid.

The dielectric liquid particularly preferably comprises at least one mineral oil, and at least one polar compound of the benzophenone or acetophenone type, or a derivative thereof.

The mineral oil is preferably chosen from naphthenic oils and paraffinic oils.

The mineral oil is obtained from the refining of a petroleum crude oil.

According to a particularly preferred embodiment of the invention, the mineral oil comprises a paraffinic carbon (Cp) content ranging from about 45 at % to about 65 at %, a naphthenic carbon (Cn) content ranging from about 35 at % to about 55 at %, and an aromatic carbon (Ca) content ranging from about 0.5 at % to about 10 at %.

In a particular embodiment, the polar compound such as benzophenone, acetophenone or a derivative thereof represents at least about 2.5% by weight, preferably at least about 3.5% by weight, and particularly preferably at least about 4% by weight, relative to the total weight of the dielectric liquid. The polar compound can improve the dielectric strength of the electrically insulating layer.

The dielectric liquid may comprise not more than about 30% by weight, preferably not more than about 20% by weight, and even more preferentially not more than about 15% by weight, of a polar compound of the benzophenone or acetophenone type or a derivative thereof, relative to the total weight of the dielectric liquid. This maximum amount ensures moderate or even low dielectric losses (e.g. less than about 10⁻³), and also prevents migration of the dielectric liquid out of the electrically insulating layer.

According to a preferred embodiment of the invention, the polar compound such as benzophenone, acetophenone or a derivative thereof is chosen from benzophenone, dibenzosuberone, fluorenone and anthrone. Benzophenone is particularly preferred.

One or more additives may form part of the constituents of the dielectric liquid, the filler-charged dielectric liquid, or the polymer composition.

The additives may be chosen from processing aids such as lubricants, compatibilizers, coupling agents, antioxidants, UV stabilizers, antioxidants, anti-copper agents, water-tree-reducing agents, pigments, and a mixture thereof.

The antioxidants are used for protecting the polymer composition from thermal stresses generated during the steps of manufacturing the cable or when the cable is operating.

The antioxidants are preferably chosen from hindered phenols, thioesters, sulfur-based antioxidants, phosphorus-based antioxidants, amine-type antioxidants, and a mixture thereof.

As examples of hindered phenols, mention may be made of 1,2-bis(3,5-di-tert-butyl-4-hydroxyhydrocinnamoyl)hydrazine (Irganox® MD 1024), pentaerythrityl tetrakis(3-(3,5-di-tert-butyl-4-hydroxyphenyl)propionate (Irganox® 1010), octadecyl 3-(3,5-di-tert-butyl-4-hydroxyphenyl)propionate (Irganox® 1076), 1,3,5-trimethyl-2,4,6-tris(3,5-di-tert-butyl-4-hydroxybenzyl)benzene (Irganox® 1330), 4,6-bis(octylthiomethyl)-o-cresol (Irgastab® KV10 or Irganox® 1520), 2,2′-thiobis(6-tert-butyl-4-methylphenol) (Irganox® 1081), 2,2′-thiodiethylenebis[3-(3,5-di-tert-butyl-4-hydroxyphenyl) propionate] (Irganox® 1035) tris(3,5-di-tert-butyl-4-hydroxybenzyl) isocyanurate (Irganox® 3114), 2,2′-oxamidobis(ethyl-3(3,5-di-tert-butyl-4-hydroxyphenyl)propionate) (Naugard XL-1), or 2,2′-methylenebis(6-tert-butyl-4-methylphenol).

As examples of sulfur-based antioxidants, mention may be made of thioethers such as didodecyl 3,3′-thiodipropionate (Irganox® PS800), distearyl thiodipropionate or dioctadecyl 3,3′-thiodipropionate (Irganox® PS802), bis[2-methyl-4-{3-n-(C₁₂ or C₁₄)alkylthiopropionyloxy}-5-tert-butylphenyl] sulfide, thiobis[2-tert-butyl-5-methyl-4,1-phenylene] bis[3-(dodecylthio)prop]onate], or 4,6-bis(octylthiomethyl)-o-cresol (Irganox® 1520 or Irgastab® KV10).

As examples of phosphorus-based antioxidants, mention may be made of tris(2,4-di-tert-butylphenyl) phosphite (Irgafos® 168) or bis(2,4-di-tert-butylphenyl)pentaerythrityl diphosphite (Ultranox® 626).

As examples of antioxidants of amine type, mention may be made of phenylenediamines (e.g. para-phenylenediamines such as 1PPD or 6PPD), diphenylaminestyrenes, diphenylamines, or 4-(1-methyl-1-phenylethyl)-N-[4-(1-methyl-1-phenylethyl)phenyl]aniline (Naugard 445), mercaptobenzimidazoles, or polymerized 2,2,4-trimethyl-1,2-dihydroquinoline (TMQ).

As examples of antioxidant mixtures that may be used according to the invention, mention may be made of Irganox B 225 which comprises an equimolar mixture of Irgafos 168 and Irganox 1010 as described above.

The antioxidant may represent from about 3% to about 25% by weight, and preferably from about 5% to about 20% by weight, relative to the total weight of the dielectric liquid.

The Polymer Composition

The thermoplastic polymer material of the polymer composition of the electrically insulating layer of the cable of the invention is preferably heterophasic (i.e. it comprises several phases). The presence of several phases generally results from the mixing of two different polyolefins, such as a mixture of a propylene polymer and an ethylene polymer or a mixture of different propylene polymers.

On conclusion of step iii), a polymer composition comprising at least said thermoplastic polymer material, said dielectric liquid, and said thermally conductive inorganic filler is obtained.

The polymer composition of the electrically insulating layer of the invention is a thermoplastic polymer composition. It is thus not crosslinkable.

In particular, the polymer composition does not comprise any crosslinking agents, silane couplers, peroxides and/or additives that enable crosslinking. The reason for this is that such agents degrade the thermoplastic polymer material based on polypropylene and polyethylene.

The polymer composition is preferably recyclable.

The polymer composition may comprise at least about 1% by weight, preferably at least about 2% by weight, particularly preferably at least about 5% by weight, and more particularly preferably at least about 10% by weight, of thermally conductive inorganic filler relative to the total weight of the polymer composition.

The polymer composition may comprise not more than about 50% by weight, particularly preferably not more than about 40% by weight, and more particularly preferably not more than about 30% by weight, of thermally conductive inorganic filler relative to the total weight of the polymer composition.

The polymer composition may typically comprise from about 0.01% to about 5% by weight, and preferably from about 0.1% to about 2% by weight of additives, relative to the total weight of the thermoplastic polymer material based on polypropylene and polyethylene.

The dielectric liquid represents from about 1% to about 20% by weight, preferably from about 2% to about 15% by weight, and particularly preferably from about 3% to about 12% by weight, relative to the total weight of the polymer composition.

The thermoplastic polymer material based on polypropylene and polyethylene may represent at least about 50% by weight, preferably at least about 70% by weight, and particularly preferably at least about 80% by weight, relative to the total weight of the polymer composition.

Step i₀)

The process may also comprise, prior to step iii), a step i₀) of preparing the dielectric liquid.

In step i₀), the dielectric liquid may be prepared by mixing the various constituents of the dielectric liquid.

Step i₀) may then be performed by mixing the mineral oil with the polar compound.

Step i₀) may be performed at a temperature ranging from about 20° C. to about 100° C., notably so as to ensure homogeneous mixing of the mineral oil with the polar compound.

One or more of the additives as defined in the invention may be added during step i₀), i), ii) or iii).

When the additive is an antioxidant, it is preferentially added in step i₀).

In other words, step i₀) involves mixing the liquid component of the dielectric liquid, and optionally the polar compound, with at least one antioxidant.

When the antioxidant is present, step i₀) involves mixing the mineral oil with optionally the polar compound, and with the antioxidant.

Step i₀) is optional. In other words, the various constituents of the dielectric liquid may be mixed with the nanofilled thermoplastic polymer material without the prior step i₀).

Step iv)

On conclusion of step iii), a homogeneous polymer composition is obtained, which may then be extruded around the elongated electrically conductive element according to step iv), to obtain an (extruded) electrically insulating layer surrounding said elongated electrically conductive element.

Step iv) may be performed using techniques that are well known to those skilled in the art, for example using an extruder.

When step iii) is performed using an extruder, step iv) consists in recovering the polymer composition formed in one or more intermediate zones of the extruder and fed to the head of the extruder for application around the elongated electrically conductive element.

In step iv), the composition comprising the nanofilled thermoplastic polymer material in the molten state and the dielectric liquid is notably passed under pressure through a die.

During step iv), the polymer composition leaving the extruder is said to be “non-crosslinked”, the processing temperature and time in the extruder being accordingly optimized.

At the extruder outlet, an extruded layer is thus obtained around said electrically conductive element, which may or may not be in direct physical contact with said elongated electrically conductive element.

The process of the invention preferably does not involve a step of crosslinking the layer obtained in step iv).

The electrically insulating layer and/or the semiconductive layer(s) of the electric cable of the invention may be obtained by successive extrusion or by coextrusion.

The various compositions may be extruded one after the other to successively surround the elongated electrically conductive element, and thus to form the various layers of the electric cable of the invention.

Alternatively, they may be extruded concomitantly by coextrusion using a single extruder head, coextrusion being a process that is well known to those skilled in the art.

During step iv), the temperature within the extrusion device is preferably higher than the melting point of the predominant polymer or the polymer with the highest melting point, among the polymers used in the composition to be implemented.

This step iv) may be performed at a temperature ranging from about 180° C. to about 240° C., and preferably ranging from about 200° C. to about 220° C.

The Electrically Insulating Layer

The electrically insulating layer of the cable of the invention is a non-crosslinked layer, in other words a thermoplastic layer.

In the invention, the term “non-crosslinked layer” or “thermoplastic layer” means a layer with a gel content according to the standard ASTM D2765-01 (xylene extraction) of not more than about 30%, preferably not more than about 20%, particularly preferably not more than about 10%, more particularly preferably not more than 5%, and even more particularly preferably 0%.

In one embodiment of the invention, the preferably non-crosslinked electrically insulating layer has a thermal conductivity of at least 0.30 W/m·K at 40° C., preferably at least 0.31 W/m·K at 40° C., particularly preferably at least 0.32 W/m. K at 40° C., more particularly preferably at least 0.33 W/m·K at 40° C., even more particularly preferably at least 0.34 W/m·K at 40° C., and even more particularly preferably at least 0.35 W/m·K at 40° C.

In a particular embodiment, the preferably non-crosslinked electrically insulating layer has a tensile strength (TS) of at least 8.5 MPa, preferably at least about 10 MPa, and particularly preferably at least about 15 MPa, before aging (according to the standard CEI 20-86).

In a particular embodiment, the preferably non-crosslinked electrically insulating layer has an elongation at break (EB) of at least about 250%, preferably at least about 300%, and particularly preferably at least about 350%, before aging (according to the standard CEI 20-86).

In a particular embodiment, the preferably non-crosslinked electrically insulating layer has a tensile strength (TS) of at least 8.5 MPa, preferably at least about 10 MPa, and particularly preferably at least about 15 MPa, after aging (according to the standard CEI 20-86).

In a particular embodiment, the preferably non-crosslinked electrically insulating layer has an elongation at break (EB) of at least about 250%, preferably at least about 300%, and particularly preferably at least about 350%, after aging (according to the standard CEI 20-86).

The tensile strength (TS) and elongation at break (EB) (before or after aging) may be determined according to the standard NF EN 60811-1-1, notably using a machine sold under the reference 3345 by the company Instron.

The aging is generally performed at 135° C. for 240 hours (or 10 days).

The electrically insulating layer of the cable of the invention is preferably a recyclable layer.

The electrically insulating layer of the invention may be a layer that is extruded, notably via processes that are well known to those skilled in the art.

The electrically insulating layer has a thickness that is variable as a function of the type of cable envisaged. In particular, when the cable in accordance with the invention is a medium-voltage cable, the thickness of the electrically insulating layer is typically from about 4 to about 5.5 mm, and more particularly about 4.5 mm. When the cable according to the invention is a high-voltage cable, the thickness of the electrically insulating layer typically ranges from 17 to 18 mm (for voltages of the order of about 150 kV) and up to thicknesses ranging from about 20 to about 25 mm for voltages above 150 kV (high-voltage cables). The abovementioned thicknesses depend on the size of the elongated electrically conductive element.

In the present invention, the term “electrically insulating layer” means a layer having an electrical conductivity which may be not more than 1×10⁻⁸ S/m (siemens per metre), preferably not more than 1×10⁻⁹ S/m, and particularly preferably not more than 1×10⁻¹⁹ S/m, measured at 25° C. in DC.

The electrically insulating layer of the invention may comprise at least the thermoplastic polymer material based on polypropylene and polyethylene, at least the thermally conductive inorganic filler, and the dielectric liquid, the abovementioned ingredients being as defined in the invention.

The proportions of the various ingredients in the electrically insulating layer may be identical to those as described in the invention for these same ingredients in the polymer composition.

The cable of the invention relates more particularly to the field of electric cables operating in direct current (DC) or alternating current (AC).

The Cable

The electrically insulating layer of the invention may surround the elongated electrically conductive element.

The elongated electrically conductive element is preferably positioned at the center of the cable.

The elongated electrically conductive element may be a single-body conductor, for instance a metal wire, or a multi-body conductor such as a plurality of twisted or untwisted metal wires.

The elongated electrically conductive element may be made of aluminum, aluminum alloy, copper, copper alloy, or a combination thereof.

According to a preferred embodiment of the invention, the electric cable comprises:
at least one semiconductive layer surrounding the elongated electrically conductive element, and
an electrically insulating layer as defined in the invention.

More particularly, the electrically insulating layer has a lower electrical conductivity than that of the semiconductive layer. More particularly, the electrical conductivity of the semiconductive layer may be at least 10 times greater than the electrical conductivity of the electrically insulating layer, preferably at least 100 times greater than the electrical conductivity of the electrically insulating layer, and particularly preferably at least 1000 times greater than the electrical conductivity of the electrically insulating layer.

The semiconductive layer may surround the electrically insulating layer. The semiconductive layer may then be an outer semiconductive layer.

The electrically insulating layer may surround the semiconductive layer. The semiconductive layer may then be an inner semiconductive layer.

The semiconductive layer is preferably an inner semiconductive layer.

The electric cable of the invention may also comprise another semiconductive layer.

Thus, in this embodiment, the cable of the invention may comprise:
at least one elongated electrically conductive element, preferably positioned at the center of the cable,
a first semiconductive layer surrounding the elongated electrically conductive element,
an electrically insulating layer surrounding the first semiconductive layer, and
a second semiconductive layer surrounding the electrically insulating layer, the electrically insulating layer being as defined in the invention.

In the present invention, the term “semiconductive layer” means a layer whose electrical conductivity may be strictly greater than 1×10⁻⁸ S/m (siemens per metre), preferably at least 1×10⁻³ S/m, and may preferably be less than 1×10³ S/m, measured at 25° C. in DC.

In a particular embodiment, the first semiconductive layer, the electrically insulating layer and the second semiconductive layer constitute a three-layer insulation. In other words, the electrically insulating layer is in direct physical contact with the first semiconductive layer, and the second semiconductive layer is in direct physical contact with the electrically insulating layer.

The first semiconductive layer (or, respectively, the second semiconductive layer) is preferably obtained from a polymer composition comprising at least one polypropylene-based thermoplastic polymer material as defined in the invention, and optionally at least one electrically conductive filler as defined in the invention.

The electrically conductive filler preferably represents an amount sufficient for the layer to be semiconductive.

Preferably, the polymer composition may comprise at least about 6% by weight of electrically conductive filler, preferably at least about 10% by weight of electrically conductive filler, preferentially at least about 15% by weight of electrically conductive filler, and even more preferentially at least about 25% by weight of electrically conductive filler, relative to the total weight of the polymer composition.

The polymer composition may comprise not more than about 45% by weight of electrically conductive filler, and preferably not more than about 40% by weight of electrically conductive filler, relative to the total weight of the polymer composition.

The first semiconductive layer (or, respectively, the second semiconductive layer) is preferably a thermoplastic layer or a non-crosslinked layer.

The cable may also comprise an outer protective sheath surrounding the electrically insulating layer (or the second semiconductive layer, if present).

The outer protective sheath may be in direct physical contact with the electrically insulating layer (or the second semiconductive layer, if present).

The outer protective sheath may be an electrically insulating sheath.

The electric cable may also comprise an electrical shield (e.g. metallic) surrounding the second semiconductive layer. In this case, the electrically insulating sheath surrounds said electrical shield and the electrical shield is between the electrically insulating sheath and the second semiconductive layer.

This metallic shield may be a “wire” shield composed of a set of copper or aluminum conductors arranged around and along the second semiconductive layer, a “ribbon” shield composed of one or more conductive copper or aluminum metal ribbons which may be laid in a helix around the second semiconductive layer, or a conductive aluminum metal ribbon laid longitudinally around the second semiconductive layer and rendered leaktight by means of adhesive in the overlapping areas of parts of said ribbon, or a “leaktight” shield of the metal tube type, possibly composed of lead or lead alloy and surrounding the second semiconductive layer. This last type of shield can notably act as a barrier to moisture, which has a tendency to penetrate the electric cable in the radial direction.

The metal shield of the electric cable of the invention may comprise a “wire shield” and a “leaktight shield” or a “wire shield” and a “ribbon shield”.

All the types of metal shield may act as earthing for the electric cable and may thus transport fault currents, for example in the case of short-circuiting in the network concerned.

Other layers, such as layers which swell in the presence of moisture, may be added between the second semiconductive layer and the metal shield, these layers providing the longitudinal leaktightness to water of the electric cable.

### BRIEF DESCRIPTION OF THE DRAWINGS

FIG. 1 illustrates a device for performing a process in accordance with the invention.

For the sake of clarity, only the elements that are essential for the understanding of the invention have been represented schematically, and are not to scale.

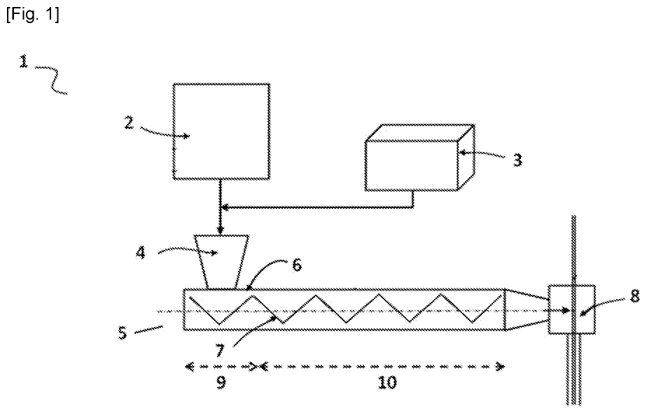

In FIG. 1, the device 1 comprises a container 2 which may be fed with granules of a nanofilled thermoplastic polymer material based on polyethylene and polypropylene (i.e. ethylene polymer+thermally conductive inorganic filler; premixed with a propylene polymer), a container 3 which may be fed with a dielectric liquid, a feed hopper 4 which may be fed at ambient temperature with the granules of the nanofilled thermoplastic polymer material contained in the container 2 and with the dielectric liquid contained in the container 3, and an extruder 5 comprising a grooved barrel 6 and/or a barrier screw 7, and also an extruder head 8. The granules of the nanofilled thermoplastic polymer material and the dielectric liquid are introduced via the feed hopper 4 into a feed zone 9 of the screw according to step iii), and then fed from the feed zone 9 to one or more intermediate zones 10 allowing the polymer composition to be transported to the extruder head 8 located at the outlet of the extruder 5 and the gradual melting of the nanofilled thermoplastic polymer material, said intermediate zones 10 being located between the feed zone 9 and the extruder head 8. Finally, at the extruder head 8, the polymer composition is applied around an elongated electrically conductive element.

### EXAMPLE

Nanofilled Polyethylene

A nanofilled polyethylene was prepared as follows: a linear low-density polyethylene LLDPE sold under the trade name BPD 3642 by Ineos was mixed with alumina sold under the trade name Timal 17 by Alteo using a Leistritz twin-screw extruder at a temperature of about 165 to 180° C., then melted at about 200° C. (screw speed: 15 rpm), to form a filler-charged polyethylene comprising 36.5% by weight of polyethylene and 63.5% by weight of alumina, relative to the total weight of the filler-charged polyethylene. The alumina used has a D50 of about 400 nm, and a specific surface area of about 8 m²/g.

Polymer Composition

A layer in accordance with the invention, i.e. obtained from a polymer composition comprising at least one thermoplastic polymer material based on polypropylene and polyethylene, at least one dielectric liquid, and at least one thermally conductive inorganic filler was prepared as detailed below.

Table 1 below collates the amounts of the compounds present in the polymer composition in accordance with the invention which are expressed as weight percentages, relative to the total weight of the polymer composition.

TABLE 1

| Ingredients of the polymer composition | Proportions |
|---|---|
| Heterophasic propylene copolymer | 7.10 |
| Statistical propylene copolymer | 42.61 |
| Linear low-density polyethylene | 18.59 |
| Thermally conductive inorganic nanofiller: alumina | 27.50 |
| Dielectric liquid | 3.70 |
| Antioxidant | 0.50 |

The origin of the compounds in Table 1 is as follows:
statistical propylene copolymer sold by the company Total Petrochemicals under the reference PPR3221;
heterophasic propylene copolymer sold by the company Basell Polyolefins under the reference Adflex® Q 200 F;
linear low-density polyethylene sold by the company Ineos under the reference BPD3642 YB;
antioxidant sold by the company Ciba under the reference Irganox® B 225 comprising an equimolar mixture of Irgafos® 168 and Irganox® 1010; and
dielectric liquid comprising 95.0% by weight of an oil sold by the company Nynas under the reference BNS 28, and 5.0% by weight of benzophenone.

Non-Crosslinked Layer

The following constituents: mineral oil, antioxidant and benzophenone of the polymer composition referenced in Table 1, are measured out and mixed with stirring at about 75° C., so as to form a dielectric liquid.

The nanofilled polyethylene is then mixed in a container with the following constituents: heterophasic propylene copolymer, additional linear low-density polyethylene, and statistical propylene copolymer of the polymer composition referenced in Table 1 and dielectric liquid as prepared above. The resulting mixture is then homogenized using a Leistritz twin-screw extruder at a temperature of about 165 to 180° C. and then melted at about 200° C. (screw speed: 15 rpm).

The homogenized and melted mixture is then formed into granules.

The granules are then hot-pressed to form a layer in the form of a plate.

The polymer composition was thus prepared in the form of a 1 mm thick layer for evaluating its mechanical properties, and also in the form of an 8 mm thick layer for performing thermal conductivity measurements.

The tensile strength (TS) and elongation at break (EB) tests were performed on the materials according to the standard NF EN 60811-1-1, using a device sold under the reference 3345 by the company Instron.

The thermal conductivity tests were performed according on the materials to the well known Transient Plane Source or TPS method using a machine sold under the reference Hot Disk TPS 2500S by the company Thermoconcept.

The results corresponding to each of these tests are given in Table 2 below:

TABLE 2

| | Layer obtained with |
|---|---|
| Properties | the polymer composition |
| TS (MPa) | 15.2 |
| EB (%) | 633 |
| TS after aging (MPa) | 13.3 |
| EB after aging (%) | 396 |
| Thermal conductivity at 40° C. (W/m · K) | 0.325 |

Taken together, these results show that incorporating a thermally conductive inorganic nanofiller as defined in the invention into an ethylene polymer according to the process of the invention improves the thermal conductivity properties while at the same time ensuring good mechanical properties, notably in terms of tensile strength and elongation at break, even after aging.

1. A process for manufacturing an electric cable having at least one elongated electrically conductive element and at least one electrically insulating layer obtained from a polymer composition having at least one thermoplastic polymer material based on polypropylene and polyethylene, at least one dielectric liquid, and at least one thermally conductive inorganic nanofiller, said process comprising steps of:
i) mixing the nanometric thermally conductive inorganic nanofiller with an ethylene polymer to form a nanofilled ethylene polymer,
ii) mixing the nanofilled ethylene polymer with at least one propylene polymer, to form a nanofilled thermoplastic polymer material,
iii) mixing the nanofilled thermoplastic polymer material with the dielectric liquid to form a polymer composition, and
iv) extruding the polymer composition around the elongated electrically conductive element.

2. The process as claimed in claim 1, wherein step i) is performed at a temperature ranging from 140° C. to 240° C.

3. The process as claimed in claim 1, wherein step i) is performed with a mixer suitable for mixing several solids, for instance a single-screw extruder, a twin-screw extruder, a Buss co-kneader, or a closed mixing device.

4. The process as claimed in claim 1, wherein, on conclusion of step i), the thermally conductive inorganic nanofiller represents from 20% to 80% by weight, relative to the total weight of the nanofilled ethylene polymer.

5. The process as claimed in claim 1, wherein the thermally conductive inorganic nanofiller is chosen from silicates, boron nitride, carbonates, metal oxides, and a mixture thereof.

6. The process as claimed in claim 1, wherein the thermally conductive inorganic nanofiller has at least one of its dimensions ranging from 1 to 800 nm.

7. The process as claimed in claim 1, wherein step ii) is performed at a temperature ranging from 180° C. to 240° C.

8. The process as claimed in claim 1, wherein step ii) is performed with a mixer suitable for mixing several solids, for instance a single-screw extruder, a twin-screw extruder, a Buss co-kneader, or a closed mixing device.

9. The process as claimed in claim 1, wherein, in step ii), the propylene polymer is used in an amount such that it represents at least 50% by weight relative to the total weight of the thermoplastic polymer material based on polypropylene and polyethylene.

10. The process as claimed in claim 1, wherein the propylene polymer is a propylene copolymer P₁ chosen from a homophasic propylene copolymer and a heterophasic propylene copolymer.

11. The process as claimed in claim 1, wherein step iii) is performed according to the following substeps:
iii-1) introducing the dielectric liquid into an extruder by means of a feed hopper,
iii-2) introducing the nanofilled thermoplastic polymer material, notably in the form of granules, into the extruder by means of the feed hopper,
iii-3) mixing the dielectric liquid and the nanofilled thermoplastic polymer material in the extruder so as to form the polymer composition, and
iii-4) melting the thermoplastic polymer material.

12. The process as claimed in claim 11, wherein substeps iii-1) and iii-2) are performed at a pressure of not more than 5 bar.

13. The process as claimed in claim 11, wherein substeps iii-3) and iii-4) are concomitant.

14. The process as claimed in claim 11, wherein the dielectric liquid and the nanofilled thermoplastic polymer material are placed in contact in the feed hopper or in the extruder.

15. The process as claimed in claim 14, wherein the placing of the dielectric liquid in contact with the nanofilled thermoplastic polymer material is performed at a temperature ranging from 15 to 80° C. and at a pressure of not more than 5 bar.
